(19) United States
(12) Patent Application Publication
(10) Pub. No.: US 2025/0386171 A1
(43) Pub. Date: Dec. 18, 2025

(54) UPLINK TRAFFIC OFFLOADING TO ROADSIDE UNITS (RSUs)

(71) Applicant: QUALCOMM Incorporated, San Diego, CA (US)

(72) Inventors: Shijun WU, San Diego, CA (US); Shailesh PATIL, San Diego, CA (US); Dan VASSILOVSKI, Del Mar, CA (US)

(21) Appl. No.: 18/744,532

(22) Filed: Jun. 14, 2024

(51) Int. Cl. H04W 4/40; H04B 7/06; H04B 17/309; H04B 17/318; H04W 4/38; H04W 92/18

(52) U.S. Cl. CPC H04W 4/40; H04B 7/0632; H04B 17/328; H04B 17/346; H04W 4/38; H04W 92/18

(57) ABSTRACT

A method for wireless communication by a sidelink (SL) user equipment (UE) includes receiving, from a roadside unit (RSU), one or more signals via an SL channel. The method also includes transmitting, to a network node, a first message indicating a switch from a cellular channel to the SL channel in accordance with one or more of channel conditions of the SL channel, the one or more channel conditions including one or more of a SL reference signal received power (RSRP), a channel busy ratio (CBR), a signal to interference and noise ratio (SINR), channel latency, channel data rate, or a channel quality indicator (CQI). The method further includes transmitting, to the RSU via the SL channel, a second message including sensor data in accordance with switching from the cellular channel to the SL channel.

### FIELD OF THE DISCLOSURE

The present disclosure relates generally to wireless communications, and more specifically to offloading uplink traffic to roadside units (RSUs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunications standards to provide a common protocol that enables different wireless devices to communicate on a municipal, national, regional, and even global level. An example telecommunications standard is fifth generation (5G) new radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the fourth generation (4G) long term evolution (LTE) standard. Narrowband (NB)-IoT and enhanced machine-type communications (eMTC) are a set of enhancements to LTE for machine type communications. There exists a need for further improvements in 5G NR technology. These improvements may also be applicable to other multi-access technologies and the telecommunications standards that employ these technologies.

Wireless communications systems may include or provide support for various types of communications systems, such as vehicle related cellular communications systems (e.g., vehicle-to-everything (V2X) communications systems). Vehicle related communications systems may be used by vehicles to increase safety and to help prevent collisions of vehicles. Information regarding inclement weather, nearby accidents, road conditions, and/or other information may be conveyed to a driver via the vehicle related communications system. In some cases, sidelink user equipment (UEs), such as vehicles, may communicate directly with each other using device-to-device (D2D) communications over a D2D wireless link. These communications can be referred to as sidelink communications.

A connected vehicle may include an onboard unit (OBU) for managing communication between the vehicle and various networks, such as mobile networks, infrastructure networks, and other surrounding entities. In some cases, the OBU may manage communications with other OBUs installed in other vehicles, roadside units (RSUs), or vulnerable road users (VRUs) (e.g., scooters or pedestrians using smartphones). These communications may be transmitted via a sidelink channel (e.g., PC5 interface). In other cases, the OBU can establish communication with a mobile or cellular network via a cellular channel (e.g., Uu interface).

### SUMMARY

In some aspects of the present disclosure, a method for wireless communication at a sidelink (SL) user equipment (UE) includes receiving, from an RSU, one or more signals via an SL channel. The method also includes transmitting, to a network node, a first message indicating a switch from a cellular channel to the SL channel in accordance with one or more of channel conditions of the SL channel, the one or more channel conditions including one or more of a SL reference signal received power (RSRP), a channel busy ratio (CBR), a signal to interference and noise ratio (SINR), channel latency, channel data rate, or a channel quality indicator (CQI). The method further includes transmitting, to the RSU via the SL channel, a second message including sensor data in accordance with switching from the cellular channel to the SL channel.

Other aspects of the present disclosure are directed to an apparatus. The apparatus includes means for receiving, from an RSU, one or more signals via an SL channel. The apparatus also includes means for transmitting, to a network node, a first message indicating a switch from a cellular channel to the SL channel in accordance with one or more of channel conditions of the SL channel, the one or more channel conditions including one or more of a SL RSRP, a CBR, a SINR, channel latency, channel data rate, or a CQI. The apparatus further includes means for transmitting, to the RSU via the SL channel, a second message including sensor data in accordance with switching from the cellular channel to the SL channel.

In other aspects of the present disclosure, a non-transitory computer-readable medium with program code recorded thereon is disclosed. The program code is executed by a processor and includes program code to receive, from an RSU, one or more signals via an SL channel. The program code also includes program code to transmit, to a network node, a first message indicating a switch from a cellular channel to the SL channel in accordance with one or more of channel conditions of the SL channel, the one or more channel conditions including one or more of a SL RSRP, a CBR, a SINR, channel latency, channel data rate, or a CQI. The program code further includes program code to transmit, to the RSU via the SL channel, a second message including sensor data in accordance with switching from the cellular channel to the SL channel.

Other aspects of the present disclosure are directed to an apparatus. The apparatus includes one or more processors, and one or more memories coupled with the one or more processors and storing processor-executable code that, when executed by the one or more processors, is configured to cause the apparatus to receive, from an RSU, one or more signals via an SL channel. Execution of the processor-executable code also causes the apparatus to transmit, to a network node, a first message indicating a switch from a cellular channel to the SL channel in accordance with one or more of channel conditions of the SL channel, the one or more channel conditions including one or more of a SL RSRP, a CBR, a SINR, channel latency, channel data rate, or a CQI. Execution of the processor-executable code further causes the apparatus to transmit, to the RSU via the SL channel, a second message including sensor data in accordance with switching from the cellular channel to the SL channel.

In some aspects of the present disclosure, a method for wireless communication at a sidelink UE includes transmitting, to a network node, a first message indicating a current location of the SL UE. The method still further includes receiving, from the network node, a second message requesting a switch from a cellular channel to an SL channel in accordance with a distance between the current location of the SL UE and a location of an RSU being less than a distance threshold. The method also includes transmitting, to the RSU via the SL channel, a third message including sensor data in accordance with switching from the cellular channel to the SL channel.

Other aspects of the present disclosure are directed to an apparatus. The apparatus includes means for transmitting, to a network node, a first message indicating a current location of the SL UE. The apparatus further includes means for receiving, from the network node, a second message requesting a switch from a cellular channel to an SL channel in accordance with a distance between the current location of the SL UE and a location of an RSU being less than a distance threshold. The apparatus further includes means for transmitting, to the RSU via the SL channel, a third message including sensor data in accordance with switching from the cellular channel to the SL channel.

In other aspects of the present disclosure, a non-transitory computer-readable medium with program code recorded thereon is disclosed. The program code is executed by a processor and includes program code to transmit, to a network node, a first message indicating a current location of the SL UE. The program code still further includes program code to receive, from the network node, a second message requesting a switch from a cellular channel to an SL channel in accordance with a distance between the current location of the SL UE and a location of an RSU being less than a distance threshold. The program code also includes program code to transmit, to the RSU via the SL channel, a third message including sensor data in accordance with switching from the cellular channel to the SL channel.

Other aspects of the present disclosure are directed to an apparatus. The apparatus includes one or more processors, and one or more memories coupled with the one or more processors and storing processor-executable code that, when executed by the one or more processors, is configured to cause the apparatus to transmit, to a network node, a first message indicating a current location of the SL UE. Execution of the processor-executable code also causes the apparatus to receive, from the network node, a second message requesting a switch from a cellular channel to an SL channel in accordance with a distance between the current location of the SL UE and a location of an RSU being less than a distance threshold. Execution of the processor-executable code further causes the apparatus to transmit, to the RSU via the SL channel, a third message including sensor data in accordance with switching from the cellular channel to the SL channel.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communications system and an access network.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a diagram illustrating an example of a vehicle-to-everything (V2X) system, in accordance with various aspects of the present disclosure.

FIG. 5 is a block diagram illustrating an example of a V2X system with a roadside unit (RSU), according to various aspects of the present disclosure.

FIG. 6 is a graph illustrating a sidelink (SL) communications scheme, in accordance with various aspects of the present disclosure.

FIG. 7 is a timing diagram illustrating an example of a V2X cloud server requesting an SL UE to switch sensor data transmissions from a cellular channel to a sidelink channel, in accordance with various aspects of the present disclosure.

FIG. 8 is a timing diagram illustrating an example of an SL UE switching sensor data transmissions from the cellular channel to the sidelink channel, in accordance with various aspects of the present disclosure.

FIG. 9 is a flow diagram illustrating an example of a process for switching sensor data transmissions from a cellular channel to a sidelink channel, in accordance with various aspects of the present disclosure.

FIG. 10 is a flow diagram illustrating an example of a process for switching sensor data transmissions from a cellular channel to a sidelink channel, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology associated with 5G wireless technologies, aspects of the present disclosure can be applied in later generations, including for 6G wireless technologies, or in other wireless communications systems.

In cellular communications networks, wireless devices may generally communicate with each other via access links with one or more network entities such as a base station or scheduling entity. Some cellular networks may also support device-to-device (D2D) communications that enable discovery of, and communications among, nearby devices using direct links between devices (for example, without passing through a base station, relay, or other network entity). D2D communications may also be referred to as point-to-point (P2P) or sidelink communications. D2D communications may be implemented using licensed or unlicensed bands. Using D2D communications, devices can avoid some of the overhead that would otherwise be involved with routing to and from a network entity. D2D communications can also enable mesh networking and device-to-network relay functionality.

Vehicle-to-everything (V2X) communication is an example of D2D communication that is specifically geared toward automotive use cases. V2X communications may enable autonomous vehicles to communicate with each other. In some examples, V2X communications may enable a group of autonomous vehicles to share respective sensor information. For example, each autonomous vehicle may include multiple sensors or sensing technologies (for example, light detection and ranging (LiDAR), radar, cameras, etc.). In most cases, an autonomous vehicle's sensors are limited to detecting objects within the sensors' line of sight. In contrast, based on the sensor information shared via V2X communications, one or more autonomous vehicles in the group of autonomous vehicles may be made aware of an out of sight object. In such examples, the object may be within a line of sight of sensors associated with another autonomous vehicle in the group of autonomous vehicles. Additionally, or alternatively, based on the sensor information shared via V2X communications, two or more autonomous vehicle in the group of autonomous vehicles may coordinate one or more actions, such as avoiding the object or maintaining a pre-determined distance between the two or more autonomous vehicles.

Sidelink (SL) communication is another example of D2D communication that enables a user equipment (UE) to communicate with another UE without tunneling through a base station and/or a core network. Sidelink communications can be communicated over a physical sidelink control channel (PSCCH) and a physical sidelink shared channel (PSSCH). The PSCCH and PSSCH are similar to a physical downlink control channel (PDCCH) and a physical downlink shared channel (PDSCH) in downlink (DL) communications between a base station and a UE. For instance, the PSCCH may carry sidelink control information (SCI) and the PSCCH may carry sidelink data (for example, user data). Each PSCCH is associated with a corresponding PSSCH, where SCI in a PSCCH may carry reservation and/or scheduling information for a sidelink data transmission in the associated PSSCH. Use cases for sidelink communications may include, among others, V2X, industrial Internet of Things (IoT) (IIoT), and/or NR-lite.

A connected vehicle may include an onboard unit (OBU) for managing communication between the vehicle and various networks, such as mobile networks, infrastructure networks, and other surrounding entities. In some cases, the OBU may manage communications with other OBUs installed in other vehicles, roadside units (RSUs), or vulnerable road users (VRUs) (e.g., scooters or pedestrians using smartphones). These communications may be transmitted via a sidelink channel (e.g., PC5 link). In other cases, the OBU can establish communication with a mobile or cellular network via a cellular channel (e.g., Uu link). The connected vehicle may be referred to as a sidelink (SL) UE (hereinafter used interchangeably).

Sensor data transmissions have various uses in automotive connectivity. In some cases, an SL UE may transmit raw (e.g., unprocessed) or processed sensor data to other vehicles or V2X cloud servers in real-time. Sensor data transmissions may also be used for tele-operated driving (ToD). In ToD, real-time sensor data from onboard sensors may be transmitted to a ToD server to operate the SL UE. These sensor data transmissions specify high uplink data rates, with bandwidth specifications dependent on onboard sensor capabilities. However, the performance of cellular systems is generally asymmetrical, favoring downlink (DL) over uplink (UL), which can bottleneck automotive connectivity. In some cases, roadside units (RSUs) may offload sensor data transmission from a cellular channel (e.g., Uu uplink) to a sidelink channel (e.g., PC5 link).

In wireless connectivity, such as automotive connective, sensor data transmission may have various use cases. For example, user equipment (UE), such as a vehicle, may transmit either raw or processed sensor data to another vehicle or a V2X application or cloud server in real-time. As another example, sensor data may be transmitted for remote driving, also known as tele-operated driving (ToD), where real-time sensor data generated by a vehicle's onboard sensors is sent to a ToD server. This server processes the data to generate appropriate actions for vehicle operation. These use cases demand high uplink data rates, with bandwidth requirements varying based on the sensor's capability-for instance, video data typically requires 8 Mbps, while Lidar data can need up to 35 Mbps. Remote driving scenarios often involve multiple sensors, further increasing the uplink bandwidth demand.

The performance and configurations of cellular systems are typically asymmetrical, with UE transmission power in the uplink (UL) being much less than that of the base station (BS) in the downlink (DL). Network resources are also configured to favor DL, resulting in better performance in DL, which suits conventional mobile applications where traffic is predominantly DL-heavy. For example, with a network coverage of −100 dBm RSRP, a UE can achieve a throughput of approximately 200 Mbps in DL, but only 0.5 Mbps in UL. This asymmetry poses a bottleneck for automotive connectivity, particularly for sensor data transmission in the uplink. The deployment of Roadside Units (RSUs) offers a solution by allowing vehicle sensor data transmission to be offloaded from a cellular uplink (e.g., Uu uplink) to a sidelink (e.g., PC5 sidelink). This switch provides several benefits, such as satisfying data rate and latency requirements of sensor data transmission, reducing communication costs (as the sidelink may operate in the ITS band, which is free for the UE), and improving the experience of other cellular users by preventing vehicle sensor data from congesting the cellular uplink. Thus, the transition from Uu uplink to PC5 sidelink in automotive connectivity is driven by the need to enhance efficiency, reliability, and cost-effectiveness in sensor data transmission.

Various aspects of the present disclosure are directed to switching sensor data transmissions from a cellular channel to a sidelink channel and vice versa. In some examples, a switch from the cellular channel to the sidelink channel or vice versa may be initiated by an SL UE, a V2X cloud server, or a network node.

In examples where the SL UE switches from the cellular channel to the sidelink channel, the SL UE may receive one or more signals from an RSU on a sidelink channel. The SL UE may determine one or more channel conditions in accordance with receiving the one or more signals. The one or more channel conditions include, but are not limited to, one or more of an SL reference signal received power (RSRP), a channel busy ratio (CBR), a signal to interference and noise ratio (SINR), channel latency, channel data rate, or a channel quality indicator (CQI). In such examples, the SL UE may transmit, to the network node, a first message indicating a switch from the cellular channel to the sidelink channel, and vice versa, in accordance with the one or more channel conditions. The SL UE may then transmit, to the RSU, a second message including sensor data in accordance with switching from the cellular channel to the sidelink channel. The RSU may then forward the sensor data to the V2X cloud server.

As discussed, in other examples, the V2X cloud server or the network node may switch sensor data transmissions from the cellular channel to the sidelink channel. In such examples, the SL UE may transmit, to the network node, a first message indicating a current location of the SL UE or an intended route of the SL UE. The network node may forward the current location or the intended route to the V2X cloud server. Based on the current location or the intended route, the network node or the V2X cloud server may determine a distance between the current location of the SL UE and a location of an RSU is less than a distance threshold. In accordance with the distance being less than the threshold, the network node or the V2X cloud server may initiate the switch from the cellular channel to the sidelink channel. In such examples, the SL UE receives, from the network node, a request to switch from the cellular channel to the sidelink channel. In some such examples, when the switch is initiated at the V2X cloud server, the request may be forwarded from the V2X cloud server to the SL UE via the network node. In accordance with receiving the request, the SL UE may transmit a third message, including sensor data, to the RSU via the sidelink channel. The RSU may then forward the sensor data to the V2X cloud server.

Particular aspects of the subject matter described in this disclosure can be implemented to realize one or more of the following potential advantages. In some examples, the described technique of a sidelink UE receiving, from an RSU, one or more signals via a sidelink channel may facilitate the SL UE determining one or more channel conditions associated with the sidelink channel. Specifically, in such examples, the SL UE may transmit, to a network node, a first message indicating sensor data transmissions will be switched from a cellular channel to the sidelink channel, and vice versa, in accordance with the one or more channel conditions associated with the sidelink channel, thus allowing the SL UE to switch sensor data transmissions from the cellular channel to the sidelink channel. Switching the sensor data transmissions from the cellular channel to the sidelink channel, and vice versa, in accordance with the one or more channel conditions associated with the sidelink channel may cause the sensor data transmissions to satisfy data rate and latency specifications, while also improving cellular communications by reducing network bandwidth based on the offloading of sensor data transmissions from the cellular channel to the sidelink channel.

Additionally, the described techniques of the SL UE transmitting, to a network node, a first message indicating a current location of the SL UE or a planned route of the SL UE enables the network node or a V2X cloud server to determine whether the distance between the SL UE and a location of an RSU is less than a distance threshold. Specifically, in such examples, by determining the distance is less than the distance threshold, the network node or the V2X cloud server may request the SL UE to switch sensor data transmissions from the cellular channel to the sidelink channel. Switching the sensor data transmissions from the cellular channel to the sidelink channel, and vice versa, in accordance with the distance between the SL UE and the location of the RSU being less than the distance threshold may reduce sensor data transmission latency, thereby causing the sensor data transmissions to satisfy data rate and latency specifications. In such examples, switching the sensor data transmissions from the cellular channel, and vice versa, to the sidelink channel may also improve cellular communications by reducing network bandwidth based on the offloading of sensor data transmissions from the cellular channel to the sidelink channel.

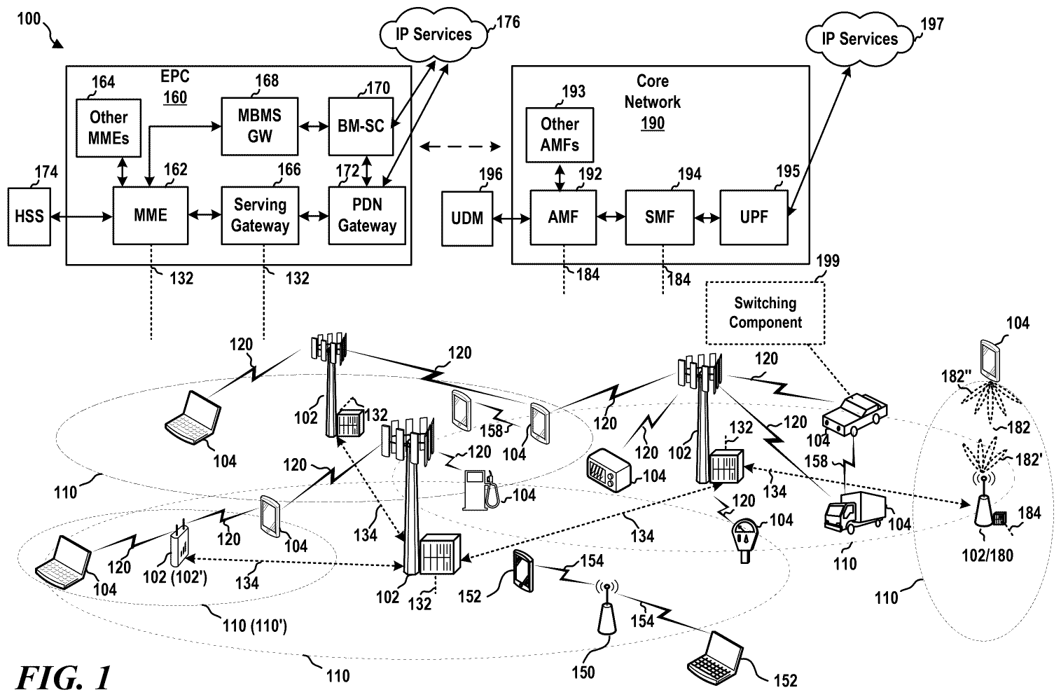

FIG. 1 is a diagram illustrating an example of a wireless

communications system and an access network 100. The wireless communications system (also referred to as a wireless wide area network (WWAN)) includes base stations 102, UEs 104, an evolved packet core (EPC) 160, and another core network 190 (e.g., a 5G core (5GC)). The base stations 102 may include macrocells (high power cellular base station) and/or small cells 102′ (low power cellular base station). The macrocells include base stations. The small cells 102′ include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (e.g., S1 interface). The base stations 102 configured for 5G NR (collectively referred to as next generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communications coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include home evolved Node Bs (eNBs) (HeNBs), which may provide service to a restricted group known as a closed subscriber group (CSG). The communications links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communications links 120 may use multiple-input and multiple-output (MIMO) antenna technology, including spatial multiplexing, beamforming, and/or transmit diversity. The communications links may be through one or more carriers. The base stations 102/UEs 104 may use spectrum up to Y MHz (e.g., 5, 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communications link 158. The D2D communications link 158 may use the DL/UL WWAN spectrum. The D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communications may be through a variety of wireless D2D communications systems, such as FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communications links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include a NR BS, a Node B, a 5G node B, an eNB, a gNodeB (gNB), an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC. Some base stations, such as gNB 180 may operate in a traditional sub 6 GHz spectrum, in millimeter wave (mmWave) frequencies, and/or near mm Wave frequencies in communication with the UE 104. When the gNB 180 operates in mm Wave or near mm Wave frequencies, the gNB 180 may be referred to as an mmWave base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmWave may extend down to a frequency of 3GHz with a wavelength of 100 millimeters. The super high frequency (SHF) band extends between 3 GHz and 30 GHz, also referred to as centimeter wave. Communications using the mm Wave/near mm Wave radio frequency band (e.g., 3 GHz-300 GHz) has extremely high path loss and a short range. The mmWave base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN gateway 172. The PDN gateway 172 provides UE IP address allocation as well as other functions. The PDN gateway 172 and the BM-SC 170 are connected to the IP services 176. The IP services 176 may include the Internet, an intranet, an IP multimedia subsystem (IMS), a PS streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) arca broadcasting a particular service, and may be responsible for session management (start/stop) and for collecting cMBMS related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality of service (QOS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit and receive point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., a parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

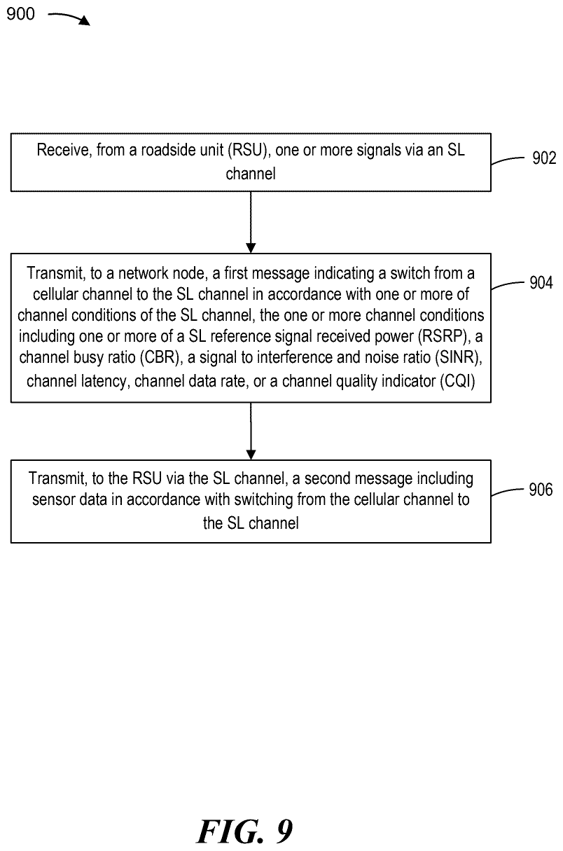

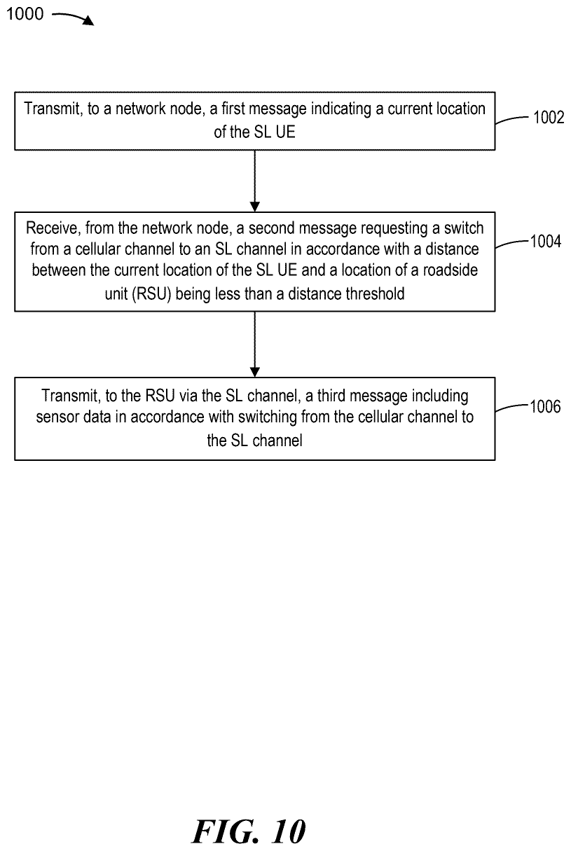

Referring again to FIG. 1, in certain aspects, a receiving device, such as the UE 104, may receive sensing information from one or more other UEs 104. The UE 104 that received the sensing information may also obtain sensing information from its own measurements. The UE 104 may include a switching component 199 configured to perform one or more operations, such as one or more operations associated with the process 900 and/or the process 1000 described with reference to FIGS. 9 and 10, respectively.

Although the following description may be focused on 5G NR, it may be applicable to other similar areas, such as LTE, LTE-A, CDMA, GSM, and other wireless technologies.

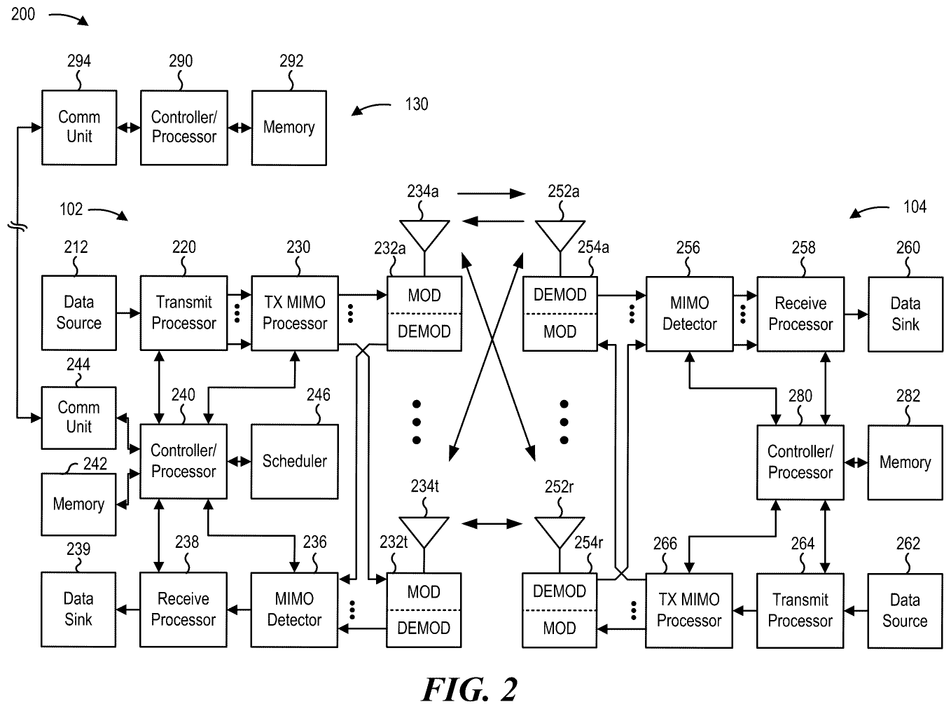

FIG. 2 shows a block diagram of a design 200 of the base station 102 and UE 104, which may be one of the base stations and one of the UEs in FIG. 1, respectively. The base station 102 may be equipped with T antennas 234a through 234t, and UE 104 may be equipped with R antennas 252a through 252r, where in general T≥1 and R≥1.

At the base station 102, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 104, antennas 252a through 252r may receive the downlink signals from the base station 102 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 104 may be included in a housing.

On the uplink, at the UE 104, a transmit processor 264 may receive and process data from a data source 262 and control information (for example, for reports comprising RSRP, RSSI, RSRQ, CQI, and/or the like) from the controller/processor 280. The transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread (DFT-s)-OFDM, CP-OFDM, and/or the like), and transmitted to the base station 102. At the base station 102, the uplink signals from the UE 104 and other UEs may be received by the antennas 234, processed by the demodulators 254, detected by a MIMO detector 236 if applicable, and further processed by a receive processor 238 to obtain decoded data and control information sent by the UE 104. The receive processor 238 may provide the decoded data to a data sink 239 and the decoded control information to a controller/processor 240. The base station 102 may include communications unit 244 and communicate to the core network 190 via the communications unit 244. The core network 190 may include a communications unit 294, a controller/processor 290, and a memory 292.

The controller/processor 240 of the base station 102, the controller/processor 280 of the UE 104, and/or any other component(s) of FIG. 2 may perform one or more techniques associated with configuring a relay-based sidelink network as described in more detail elsewhere. For example, the controller/processor 240 of the base station 102, the controller/processor 280 of the UE 104, and/or any other component(s) of FIG. 2 may perform or direct operations of, for example, the processes of FIGS. 10 and 12 and/or other processes as described. Memories 242 and 282 may store data and program codes for the base station 102 and UE 104, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (cNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

At least one of the transmit processor 264, the receive processor 258, and the controller/processor 280 may be configured to perform aspects in connection with the switching component 199 of FIG. 1. Additionally, at least one of the transmit processor 220, the receive processor 238, and the controller/processor 240 may be configured to perform aspects in connection with switching component 199 of FIG. 1.

In some aspects, the UE 104 may include means for receiving, from an RSU, one or more signals via an SL channel; means for transmitting, to a network node, a first message indicating a switch from a cellular channel to the SL channel in accordance with one or more of channel conditions of the SL channel, the one or more channel conditions including one or more of a SL RSRP, a CBR, a SINR, channel latency, channel data rate, or a CQI; and means for transmitting, to the RSU via the SL channel, a second message including sensor data in accordance with switching from the cellular channel to the SL channel. Additionally, or alternatively, the UE 104 may include means for transmitting, to a network node, a first message indicating a current location of the SL UE; means for receiving, from the network node, a second message requesting a switch from a cellular channel to an SL channel in accordance with a distance between the current location of the SL UE and a location of a roadside unit (RSU) being less than a distance threshold; and means for transmitting, to the RSU via the SL channel, a third message including sensor data in accordance with switching from the cellular channel to the SL channel. Such means may include one or more components of the UE 104 described in connection with FIGS. 1 and 2.

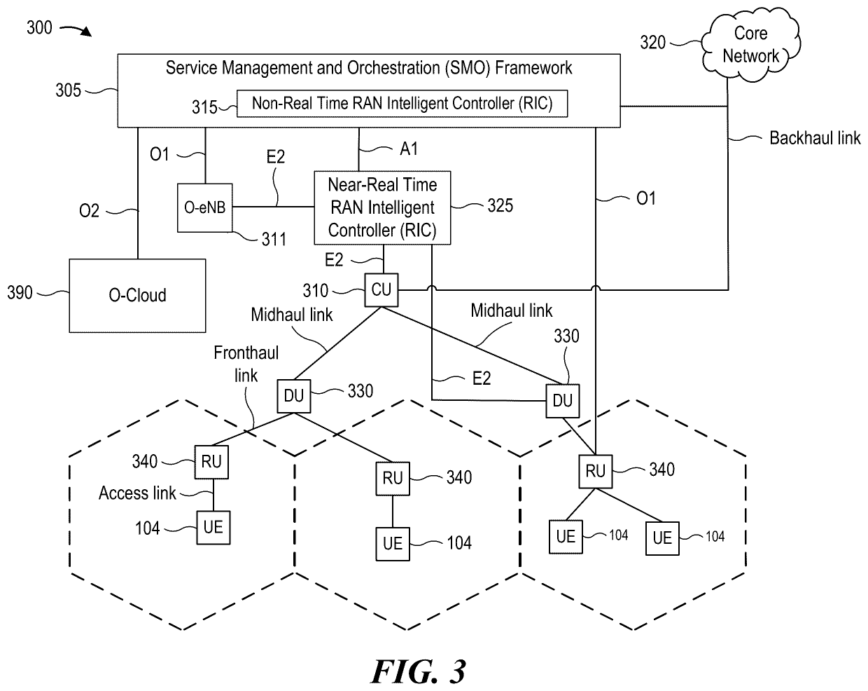

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-cNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

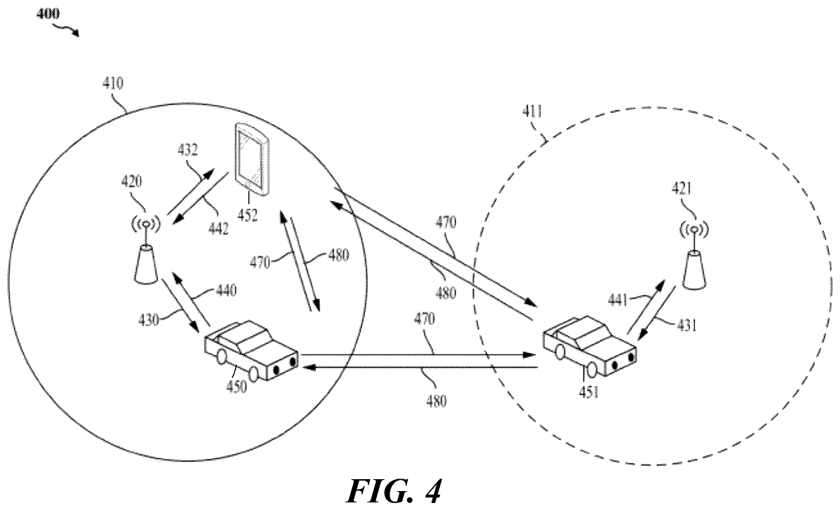

FIG. 4 is a diagram of a device-to-device (D2D) communications system 400, including V2X communications, in accordance with various aspects of the present disclosure. For example, the D2D communications system 400 may include V2X communications, (e.g., a first UE 450 communicating with a second UE 451). In some aspects, the first UE 450 and/or the second UE 451 may be configured to communicate in a licensed radio frequency spectrum and/or a shared radio frequency spectrum. The shared radio frequency spectrum may be unlicensed, and therefore multiple different technologies may use the shared radio frequency spectrum for communications, including new radio (NR), LTE, LTE-Advanced, licensed assisted access (LAA), dedicated short range communications (DSRC), MuLTEFire, 4G, and the like. The foregoing list of technologies is to be regarded as illustrative, and is not meant to be exhaustive.

The D2D communications system 400 may use NR radio access technology. Of course, other radio access technologies, such as LTE radio access technology, may be used. In D2D communications (e.g., V2X communications or vehicle-to-vehicle (V2V) communications), the UEs 450, 451 may be on networks of different mobile network operators (MNOs). Each of the networks may operate in its own radio frequency spectrum. For example, the air interface to a first UE 450 (e.g., Uu interface) may be on one or more frequency bands different from the air interface of the second UE 451. The first UE 450 and the second UE 451 may communicate via a sidelink component carrier, for example, via the PC5 interface. In some examples, the MNOs may schedule sidelink communications between or among the UEs 450, 451 in licensed radio frequency spectrum and/or a shared radio frequency spectrum (e.g., 5 GHz radio spectrum bands).

The shared radio frequency spectrum may be unlicensed, and therefore different technologies may use the shared radio frequency spectrum for communications. In some aspects, a D2D communications (e.g., sidelink communications) between or among UEs 450, 451 is not scheduled by MNOs. The D2D communications system 400 may further include a third UE 452.

The third UE 452 may operate on the first network 410 (e.g., of the first MNO) or another network, for example. The third UE 452 may be in D2D communications with the first UE 450 and/or second UE 451. The first base station 420 (e.g., gNB) may communicate with the third UE 452 via a downlink (DL) carrier 432 and/or an uplink (UL) carrier 442. The DL communications may be use various DL resources (e.g., DL subframes and/or DL channels). The UL communications may be performed via the UL carrier 442 using various UL resources (e.g., UL subframes and/or UL channels).

The first network 410 operates in a first frequency spectrum and includes the first base station 420 (e.g., gNB) communicating at least with the first UE 450, for example, as described in FIGS. 1-3. The first base station 420 (e.g., gNB) may communicate with the first UE 450 via a DL carrier 430 and/or an UL carrier 440. The DL communications may be use various DL resources (e.g., DL subframes and/or DL channels). The UL communications may be performed via the UL carrier 440 using various UL resources (e.g., UL subframes and/or UL channels).

In some aspects, the second UE 451 may be on a different network from the first UE 450. In some aspects, the second UE 451 may be on a second network 411 (e.g., of the second MNO). The second network 411 may operate in a second frequency spectrum (e.g., a second frequency spectrum different from the first frequency spectrum) and may include the second base station 421 (e.g., gNB) communicating with the second UE 451, for example, as described in FIGS. 1-3.

The second base station 421 may communicate with the second UE 451 via a DL carrier 431 and an UL carrier 441. The DL communications are performed via the DL carrier 431 using various DL resources (e.g., DL subframes and/or DL channels). The UL communications are performed via the UL carrier 441 using various UL resources (e.g., UL subframes and/or UL channels).

In conventional systems, the first base station 420 and/or the second base station 421 assign resources to the UEs for device-to-device (D2D) communications (e.g., V2X communications and/or V2V communications). For example, the resources may be a pool of UL resources, both orthogonal (e.g., one or more frequency division multiplexing (FDM) channels) and non-orthogonal (e.g., code division multiplexing (CDM)/resource spread multiple access (RSMA) in each channel). The first base station 420 and/or the second base station 421 may configure the resources via the PDCCH (e.g., faster approach) or RRC (e.g., slower approach).

In some systems, each UE 450, 451 autonomously selects resources for D2D communications. For example, each UE 450, 451 may sense and analyze channel occupation during the sensing window. The UEs 450, 451 may use the sensing information to select resources from the sensing window. As discussed, one UE 451 may assist another UE 450 in performing resource selection. The UE 451 providing assistance may be referred to as the receiver UE or partner UE, which may potentially notify the transmitter UE 450. The transmitter UE 450 may transmit information to the receiving UE 451 via sidelink communications.

The D2D communications (e.g., V2X communications and/or V2V communications) may be carried out via one or more sidelink carriers 470, 480. The one or more sidelink carriers 470, 480 may include one or more channels, such as a physical sidelink broadcast channel (PSBCH), a physical sidelink discovery channel (PSDCH), a physical sidelink shared channel (PSSCH), and a physical sidelink control channel (PSCCH), for example.

In some examples, the sidelink carriers 470, 480 may operate using the PC5 interface. The first UE 450 may transmit to one or more (e.g., multiple) devices, including to the second UE 451 via the first sidelink carrier 470. The second UE 451 may transmit to one or more (e.g., multiple) devices, including to the first UE 450 via the second sidelink carrier 480.

In some aspects, the UL carrier 440 and the first sidelink carrier 470 may be aggregated to increase bandwidth. In some aspects, the first sidelink carrier 470 and/or the second sidelink carrier 480 may share the first frequency spectrum (with the first network 410) and/or share the second frequency spectrum (with the second network 411). In some aspects, the sidelink carriers 470, 480 may operate in an unlicensed/shared radio frequency spectrum.

In some aspects, sidelink communications on a sidelink carrier may occur between the first UE 450 and the second UE 451. In an aspect, the first UE 450 may perform sidelink communications with one or more (e.g., multiple) devices, including the second UE 451 via the first sidelink carrier 470. For example, the first UE 450 may transmit a broadcast transmission via the first sidelink carrier 470 to the multiple devices (e.g., the second and third UEs 451, 452). The second UE 451 (e.g., among other UEs) may receive such broadcast transmission. Additionally, or alternatively, the first UE 450 may transmit a multicast transmission via the first sidelink carrier 470 to the multiple devices (e.g., the second and third UEs 451, 452). The second UE 451 and/or the third UE 452 (e.g., among other UEs) may receive such multicast transmission. The multicast transmissions may be connectionless or connection-oriented. A multicast transmission may also be referred to as a groupcast transmission.

Furthermore, the first UE 450 may transmit a unicast transmission via the first sidelink carrier 470 to a device, such as the second UE 451. The second UE 451 (e.g., among other UEs) may receive such unicast transmission. Additionally, or alternatively, the second UE 451 may perform sidelink communications with one or more (e.g., multiple) devices, including the first UE 450 via the second sidelink carrier 480. For example, the second UE 451 may transmit a broadcast transmission via the second sidelink carrier 480 to the multiple devices. The first UE 450 (e.g., among other UEs) may receive such broadcast transmission.

In another example, the second UE 451 may transmit a multicast transmission via the second sidelink carrier 480 to the multiple devices (e.g., the first and third UEs 450, 452). The first UE 450 and/or the third UE 452 (e.g., among other UEs) may receive such multicast transmission. Further, the second UE 451 may transmit a unicast transmission via the second sidelink carrier 480 to a device, such as the first UE 450. The first UE 450 (e.g., among other UEs) may receive such unicast transmission. The third UE 452 may communicate in a similar manner.

In some aspects, for example, such sidelink communications on a sidelink carrier between the first UE 450 and the second UE 451 may occur without having MNOs allocating resources (e.g., one or more portions of a resource block (RB), slot, frequency band, and/or channel associated with a sidelink carrier 470, 480) for such communications and/or without scheduling such communications. Sidelink communications may include traffic communications (e.g., data communications, control communications, paging communications and/or system information communications). Further, sidelink communications may include sidelink feedback communications associated with traffic communications (e.g., a transmission of feedback information for previously-received traffic communications). Sidelink communications may employ at least one sidelink communications structure having at least one feedback symbol. The feedback symbol of the sidelink communications structure may allot for any sidelink feedback information that may be communicated in the device-to-device (D2D) communications system 400 between devices (e.g., a first UE 450, a second UE 451, and/or a third UE 452). As discussed, a UE may be a vehicle (e.g., UE 450, 451), a mobile device (e.g., 452), or another type of device. In some cases, a UE may be a special UE, such as a roadside unit (RSU).

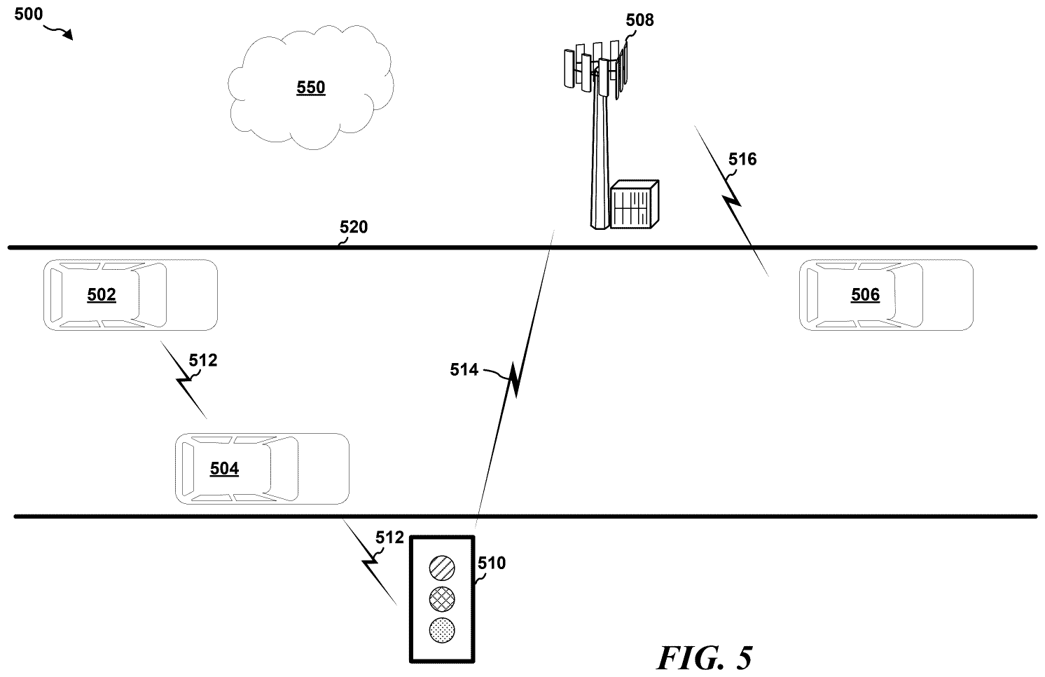

FIG. 5 illustrates an example of a vehicle-to-everything (V2X) system with a roadside unit (RSU), according to aspects of the present disclosure. As shown in FIG. 5, V2x system 500 includes a transmitter UE 504 transmits data to an RSU 510 and a receiving UE 502 via sidelink transmissions 512. Additionally, or alternatively, the RSU 510 may transmit data to the transmitter UE 504 via a sidelink transmission 512 on a sidelink channel. The RSU 510 may forward data received from the transmitter UE 504 to a network node (e.g., gNB) 508 via an UL transmission 514 on a cellular channel. The gNB 508 may transmit the data received from the RSU 510 to other UEs 506 via a DL transmission 516. The RSU 510 may be incorporated with traffic infrastructure (e.g., traffic light, light pole, etc.) For example, as shown in FIG. 5, the RSU 510 is a traffic signal positioned at a side of a road 520. Additionally, or alternatively, RSUs 510 may be stand-alone units. In the example of FIG. 5, the RSU 510 and the network node 508 may communicate with a V2X cloud server 550. The V2X cloud server 500 may also be an example of a V2X application server or a ToD server. The V2X cloud server 500 may communicate with the network node 508 and the RSU 510 via a backhaul link (e.g., X2 interface) or another type of communication interface.

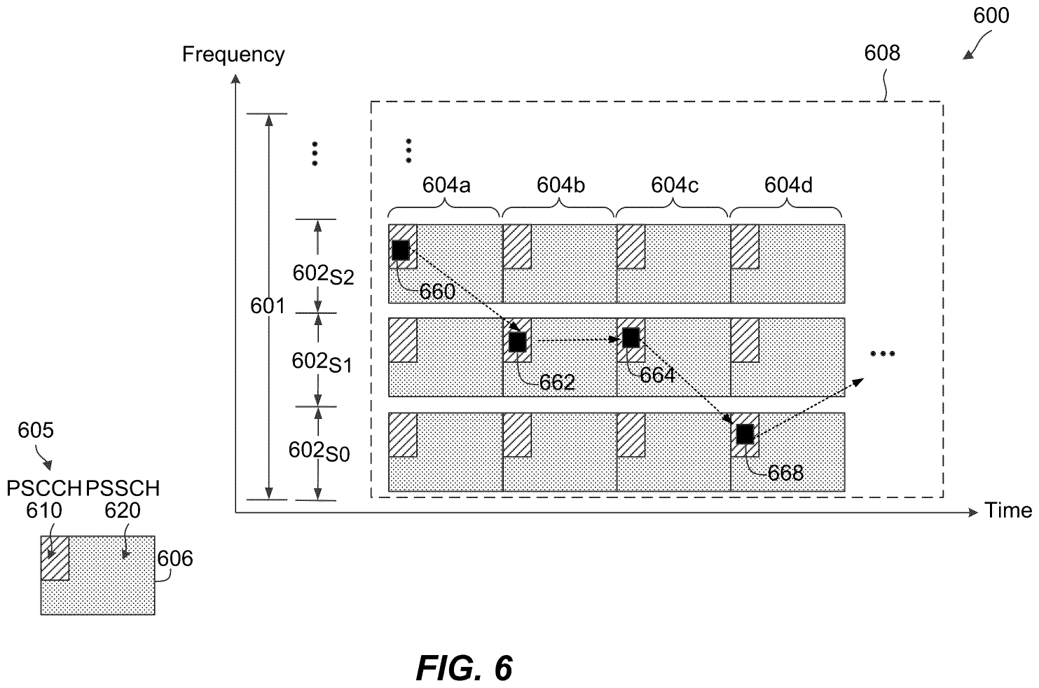

FIG. 6 is a graph illustrating a sidelink (SL) communications scheme, in accordance with various aspects of the present disclosure. A scheme 600 may be employed by UEs such as the UEs 104 in a network such as the network 100. In FIG. 6, the x-axis represents time and the y-axis represents frequency. The CV2X channels may be for 3GPP Release 16 and beyond.

In the scheme 600, a shared radio frequency band 601 is partitioned into multiple subchannels or frequency subbands 602 (shown as 602_{S0}, 602_{S1}, 602_{S2}) in frequency and multiple sidelink frames 604 (shown as 604a, 604b, 604c, 604d) in time for sidelink communications. The frequency band 601 may be at any suitable frequencies. The frequency band 601 may have any suitable bandwidth (BW) and may be partitioned into any suitable number of frequency subbands 602. The number of frequency subbands 602 can be dependent on the sidelink communications BW requirement.

Each sidelink frame 604 includes a sidelink resource 606 in each frequency subband 602. A legend 605 indicates the types of sidelink channels within a sidelink resource 606. In some instances, a frequency gap or guard band may be specified between adjacent frequency subbands 602, for example, to mitigate adjacent band interference. The sidelink resource 606 may have a substantially similar structure as an NR sidelink resource. For instance, the sidelink resource 606 may include a number of subcarriers or RBs in frequency and a number of symbols in time. In some instances, the sidelink resource 606 may have a duration between about one millisecond (ms) to about 20 ms. Each sidelink resource 606 may include a PSCCH 610 and a PSSCH 620. The PSCCH 610 and the PSSCH 620 can be multiplexed in time and/or frequency. The PSCCH 610 may be for part one of a control channel (CCH), with the second part arriving as a part of the shared channel allocation. In the example of FIG. 6, for each sidelink resource 606, the PSCCH 610 is located during the beginning symbol(s) of the sidelink resource 606 and occupies a portion of a corresponding frequency subband 602, and the PSSCH 620 occupies the remaining time-frequency resources in the sidelink resource 606. In some instances, a sidelink resource 606 may also include a physical sidelink feedback channel (PSFCH), for example, located during the ending symbol(s) of the sidelink resource 606. In general, a PSCCH 610, a PSSCH 620, and/or a PSFCH may be multiplexed within a sidelink resource 606.

The PSCCH 610 may carry SCI 660 and/or sidelink data. The sidelink data can be of various forms and types depending on the sidelink application. For instance, when the sidelink application is a V2X application, the sidelink data may carry V2X data (e.g., vehicle location information, traveling speed and/or direction, vehicle sensing measurements, etc.). Alternatively, when the sidelink application is an IIoT application, the sidelink data may carry IIoT data (e.g., sensor measurements, device measurements, temperature readings, etc.). The PSFCH can be used for carrying feedback information, for example, HARQ ACK/NACK for sidelink data received in an earlier sidelink resource 606.

In an NR sidelink frame structure, the sidelink frames 604 in a resource pool 608 may be contiguous in time. A sidelink UE (e.g., the UEs 104) may include, in SCI 660, a reservation for a sidelink resource 606 in a later sidelink frame 604. Thus, another sidelink UE (e.g., a UE in the same NR-U sidelink system) may perform SCI sensing in the resource pool 608 to determine whether a sidelink resource 606 is available or occupied. For instance, if the sidelink UE detected SCI indicating a reservation for a sidelink resource 606, the sidelink UE may refrain from transmitting in the reserved sidelink resource 606. If the sidelink UE determines that there is no reservation detected for a sidelink resource 606, the sidelink UE may transmit in the sidelink resource 606. As such, SCI sensing can assist a UE in identifying a target frequency subband 602 to reserve for sidelink communications and to avoid intra-system collision with another sidelink UE in the NR sidelink system. In some aspects, the UE may be configured with a sensing window for SCI sensing or monitoring to reduce intra-system collision.

In some aspects, the sidelink UE may be configured with a frequency hopping pattern. In this regard, the sidelink UE may hop from one frequency subband 602 in one sidelink frame 604 to another frequency subband 602 in another sidelink frame 604. In the illustrated example of FIG. 6, during the sidelink frame 604a, the sidelink UE transmits SCI 660 in the sidelink resource 606 located in the frequency subband 602_{S2} to reserve a sidelink resource 606 in a next sidelink frame 604b located at the frequency subband 602_{S1}. Similarly, during the sidelink frame 604b, the sidelink UE transmits SCI 662 in the sidelink resource 606 located in the frequency subband 602_{S1} to reserve a sidelink resource 606 in a next sidelink frame 604c located at the frequency subband 602S1. During the sidelink frame 604c, the sidelink UE transmits SCI 664 in the sidelink resource 606 located in the frequency subband 602_{S1} to reserve a sidelink resource 606 in a next sidelink frame 604d located at the frequency subband 602_{S0}. During the sidelink frame 604d, the sidelink UE transmits SCI 668 in the sidelink resource 606 located in the frequency subband 602_{S0}. The SCI 668 may reserve a sidelink resource 606 in a later sidelink frame 604.

The SCI can also indicate scheduling information and/or a destination identifier (ID) identifying a target receiving sidelink UE for the next sidelink resource 606. Thus, a sidelink UE may monitor SCI transmitted by other sidelink UEs. Upon detecting SCI in a sidelink resource 606, the sidelink UE may determine whether the sidelink UE is the target receiver based on the destination ID. If the sidelink UE is the target receiver, the sidelink UE may proceed to receive and decode the sidelink data indicated by the SCI. In some aspects, multiple sidelink UEs may simultaneously communicate sidelink data in a sidelink frame 604 in different frequency subband (e.g., via frequency division multiplexing (FDM)). For instance, in the sidelink frame 604b, one pair of sidelink UEs may communicate sidelink data using a sidelink resource 606 in the frequency subband 602S2 while another pair of sidelink UEs may communicate sidelink data using a sidelink resource 606 in the frequency subband 602S1.

In some aspects, the scheme 600 is used for synchronous sidelink communications. That is, the sidelink UEs may be synchronized in time and are aligned in terms of symbol boundary, sidelink resource boundary (e.g., the starting time of sidelink frames 604). The sidelink UEs may perform synchronization in a variety of forms, for example, based on sidelink synchronization signal blocks (SSBs) received from a sidelink UE and/or NR-U SSBs received from a base station (e.g., the base station 102) while in-coverage of the base station. In some aspects, the sidelink UE may be pre-configured with the resource pool 608 in the frequency band 601, for example, while in coverage of a serving base station. The resource pool 608 may include a plurality of sidelink resources 606. The base station can configure the sidelink UE with a resource pool configuration indicating resources in the frequency band 601 and/or the subbands 602 and/or timing information associated with the sidelink frames 604. In some aspects, the scheme 600 includes mode-2 RRA (e.g., supporting autonomous radio resource allocation (RRA) that can be used for out-of-coverage sidelink UEs or partial-coverage sidelink UEs).

Vehicle-to-everything (V2X) communication includes various types of connections. For example, vehicle-to-vehicle (V2V) communication is an example of direct communication between two vehicles (e.g., SL UEs), facilitated through a sidelink, specifically the PC5 interface. Vehicle-to-pedestrian (V2P) communication is another type of V2X communication, where a vehicle communicates directly with a UE carried by a pedestrian, also via the PC5 interface. Vehicle-to-network (V2N) communication occurs between a vehicle and a network node (e.g., base station or gNB), using both downlink and uplink on a cellular channel (e.g., Uu interface). Lastly, vehicle-to-infrastructure (V2I) communication involves a vehicle communicating with an RSU, again using the sidelink channel.

A connected vehicle may include an onboard unit (OBU) for managing communication between the vehicle and various networks, such as mobile networks, infrastructure networks, and other surrounding entities. In some cases, the OBU may manage communications with other OBUs installed in other vehicles, roadside units (RSUs), or vulnerable road users (VRUs) (e.g., scooters or pedestrians using smartphones). These communications may be transmitted via a sidelink channel (e.g., PC5 link). In other cases, the OBU can establish communication with a mobile or cellular network via a cellular channel (e.g., Uu link). The connected vehicle may be referred to as a sidelink (SL) UE (hereinafter used interchangeably).

Sensor data transmissions have various uses in automotive connectivity. In some examples, an SL UE (e.g., connected vehicle) may transmit raw or processed sensor data to another vehicle or a vehicle-to-everything (V2X) cloud server in real-time, a scenario known as sensor sharing. The V2X cloud server may also be referred to as a V2X application server. In other examples, sensor data transmissions may be used for remote driving, also referred to as tele-operated driving (ToD). In such examples, real-time sensor data generated by onboard vehicle sensors are transmitted to a ToD server. The ToD server processes the data to generate appropriate actions for the operation of the SL UE.

The transmission of sensor data from the SL UE necessitates a high uplink data rate. For raw sensor data transmission, the bandwidth specifications may be contingent on the onboard sensor capability and other factors. For example, the bandwidth for video data transmission may be eight megabits per second (8 Mbps), while the bandwidth for light detection and ranging (LiDAR) data transmission is 35 Mbps. For sensor data transmission from the SL UE to the ToD server, the per-sensor bandwidth specifications may be similar to raw sensor data transmission. This is because ToD may use data from multiple sensors, leading to an increase in an amount of uplink data.

In most cases, cellular communications systems are generally asymmetrical, such that uplink transmission power of a UE is less than a downlink transmission power of a network node. Network resources also tend to be downlink-heavy, resulting in superior performance in cellular downlink, which may be suitable for conventional mobile applications because the associated traffic is also downlink-heavy. For example, for network coverage with −100 dBm reference signal received power (RSRP), the downlink throughput measured at a UE may be 200 Mbps, while the uplink throughput may be 0.5 Mbps.

When considering automotive connectivity and vehicle sensor data transmission in the uplink, the uplink performance may be a bottleneck. In such cases, roadside units (RSUs) may be used for vehicle sensor data transmission. In areas with RSU deployment, the vehicle's sensor data transmission can be offloaded from a cellular channel (e.g., uplink transmissions) to a sidelink channel.

Various aspects of the present disclosure are directed to switching sensor data transmissions from a cellular channel to a sidelink channel. In some examples, a switch from the cellular channel to the sidelink channel, and vice versa, may be initiated by an SL UE, a V2X cloud server, or a network node.

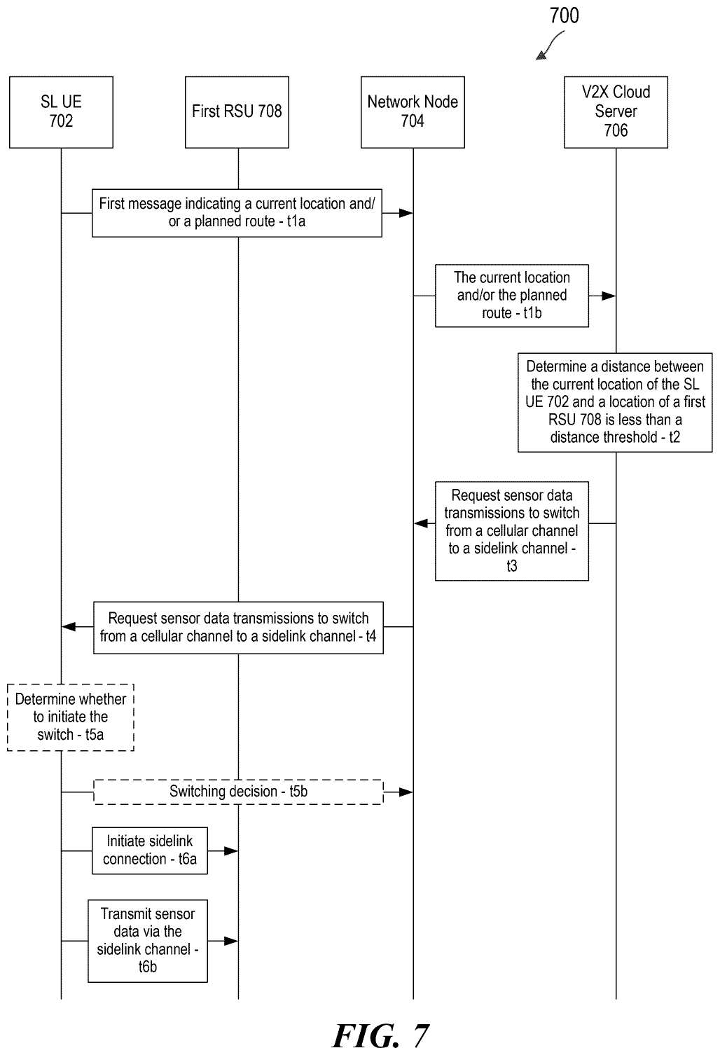

FIG. 7 is a timing diagram 700 illustrating an example of a V2X cloud server 706 requesting an SL UE 702 to switch sensor data transmissions from a cellular channel to a sidelink channel, in accordance with various aspects of the present disclosure. In the example of FIG. 7, the SL UE 702 may be in communication with a network node 704. The SL UE 702 may be an example of a UE 104 described with reference to FIGS. 1, 2, and 3, a UE 450, 451, or 452 described with reference to FIG. 4, or a UE 502, 504, or 506 described with reference to FIG. 5. The network node 704 may be an example of a network node 102 or a core network 190 described with reference to FIGS. 1 and 2, a CU 310, DU 330, or RU 340 described with reference to FIG. 3, a base station 420 or 421 described with reference to FIG. 4, or a network node 508 described with reference to FIG. 5. The V2X cloud server 706 may be an example of the V2X cloud server 550 described with reference to FIG. 5. The V2X cloud server 706 may serve as a ToD server.

In the example of FIG. 7, prior to time t1, the SL UE 702 may transmit sensor data to the network node 704 via a cellular channel. The network node 704 may forward the sensor data to the V2X cloud server 706. As shown in the example of FIG. 7, at time t1a, the SL UE 702 may transmit, to the network node 704, a first message indicating one or both of a current location of the SL UE 702 or a planned route (e.g., navigation information). The first message may be included with a sensor data transmission. Alternatively, the first message may be separately transmitted. In some examples, the first message my be periodically transmitted. At time t1b, the network node 704 may forward the current location of the SL UE 702 and/or the planned route to the V2X cloud server 706. In some examples, the V2X cloud server 706 may be aware of the locations and availability of one or more RSUs.

At time t2, based on the current location of the SL UE 702 and/or the planned route, as well as the locations and availability of the one or more RSUs, the V2X cloud server 706 may determine a distance between the current location of the SL UE 702 and a location of a first RSU 708 of the one or more RSUs is less than a distance threshold. That is, the V2X cloud server 706 may determine that the SL UE 702 is within a serving area of the first RSU 708. The first RSU 708 may be an example of an RSU 510 described with reference to FIG. 5.

At time t3, in accordance with determining the distance between the current location of the SL UE 702 and the location of the first RSU 708 is less than a distance threshold, the V2X cloud server 706 may transmit a message to the network node 704 requesting sensor data transmissions to switch from a cellular channel to a sidelink channel. At time t4, the network node 704 forwards the message to the SL UE 702.

In some examples, at time t5a, in accordance with receiving the request at time t4, the SL UE 702 may determine whether to initiate the switching. That is, the request to switch sensor data transmissions to the sidelink channel may be conditional or suggestive. In such examples, the SL UE 702 may have the autonomy to decide whether to switch sensor data transmissions to the sidelink channel. This decision may be influenced by other information available to the SL UE 702. For example, the decision to switch sensor data transmissions to the sidelink channel may be based on one or more factors, such as a cellular uplink (UL) data rate, latency experienced by the SL UE 702 on the cellular channel, a sidelink data rate, latency experienced by the SL UE 702 on the sidelink channel or in relation to the first RSU 708, or the sidelink channel busy ratio (CBR). Aspects of the present disclosure are not limited to the one or more described factors; others factors may be used by the SL UE 702 when determining whether to switch sensor data transmissions to the sidelink channel. In such examples, in accordance with determining whether to initiate the switching (time t5a), the SL UE 702 may transmit, to the network node 704, a message indicating its decision (e.g., switching decision) on whether the SL UE 702 accepts or rejects the suggested switch (time t5b). The network node 704 may forward the switching decision to the V2X cloud server 706 (not shown in the example of FIG. 7). In other examples, the request received at time t4 is not conditional.

In the example of FIG. 7, at time t6a, the SL UE 702 may initiate a sidelink connection with the first RSU 708, if a connection has not been established. After establishing the sidelink connection, the SL UE 702 redirects sensor data (e.g., IP packets) associated with one or more applications (e.g., vehicle applications) from a cellular protocol stack to a sidelink protocol stack, and transmits the sensor data via the sidelink channel (time t6b). In examples where the request received at time t4 is conditional, the operations at time t6a and t6b may be performed in response to the SL UE 702 determining to initiate the switching at time t5a. Alternatively, when the request received at time t4 is unconditional, the operations at time toa and t6b may be responsive to the SL UE 702 receiving the request. At time t6b, the SL UE 702 transmits sensor data to the first RSU 708, via the sidelink channel, in accordance with switching the sensor data transmissions from the cellular channel to the sidelink channel. The first RSU 708 may forward the sensor data to the V2X cloud server 706. The sensor data transmissions may use one or more sidelink logical channels and one or more sidelink radio bearers. In some examples, when the request received at time t4 is conditional, if the SL UE 702 rejects the switch, the sensor data transmissions may remain on the cellular channel and may be transmitted to the network node 704.

In some examples, in addition to, or alternate from, a distance between the SL UE 702 and an RSU of the one or more RSUs, the V2X cloud server 706 may request switching sensor data transmissions from the sidelink channel to the cellular channel based on one or more channel conditions. In some examples, the switch may be in accordance with a sidelink channel busy ratio (CBR) measurement. In such examples, the switch is requested if the sidelink CBR measured by the SL UE 702 is less than a CBR threshold. For example, the SL UE 702 may report the sidelink CBR measurement to the V2X cloud server 706, via the network node 704, and the V2X cloud server 708 may then determine whether to initiate the switch based on the CBR measurement. Alternatively, the V2X cloud server 706 may determine a CBR threshold and indicate the CBR threshold to the SL UE 702. In this example, the switching may be conditioned on whether the measured CBR is less than this CBR threshold. That is, the SL UE 702 may switch sensor data transmissions from the sidelink channel to the cellular channel in response to the measured CBR being less than this CBR threshold, without reporting the measured CBR to the V2X cloud server 708. In some other examples, the CBR threshold may be pre-configured at the SL UE 702. The SL UE 702 may switch sensor data transmissions from the sidelink channel to the cellular channel in response to the measured CBR being less than the pre-configured CBR threshold, without reporting the measured CBR to the V2X cloud server 706.

Additionally, or alternatively, switching may be conditioned on a latency measurement on the sidelink channel. For example, the latency measurement may be associated with one or more transmissions between the SL UE 702 and the first RSU 708. This latency measurement may be one or more of a round-trip time (from the SL UE 702 to the V2X cloud server 706 and back to the SL UE 702 via the first RSU 708), one-way latency (from the SL UE 702 to the V2X cloud server 706 via the first RSU 708), or over-the-air latency (directly from the SL UE 702 to the first RSU 708). The switching may be initiated if the measured latency satisfies sensor data transmission latency specifications.

Additionally, or alternatively, the switching may be based on a data rate associated with transmissions from the SL UE 702 to the first RSU 708. In such examples, implementation details may be specific to the SL UE 702. Additionally, or alternatively, the switching may be based on RSRP or SINR measurements associated with transmissions from the SL UE 702 to the first RSU 708.

Additionally, or alternatively, the switching may be based on a data rate and/or latency measurements associated with cellular transmissions between the SL UE 702 and the network node 704. Additionally, or alternatively, the switching may be based on RSRP or SINR measurements associated with downlink transmissions on the cellular channel.

In some implementations, the switching may be initiated by the network node 704 instead of the V2X cloud server 706. In such implementations, the process for switching may be similar to the process described with respect to FIG. 7. However, the network node 704 determines whether to switch sensor data transmissions from the cellular channel to the sidelink channel, and vice versa, based on the network node's 704 implementation. Upon determining that a switching condition is satisfied, the network node 704 may transmit, to the SL UE 702, a message including a request to switch sensor data transmissions from the cellular channel to the sidelink channel. Similar to the example of FIG. 7, in some examples, the switching request transmitted by the network node 704 may be conditional. In other examples, the switching request is unconditional.

In some examples, each of the one or more RSUs may be independent of a mobile network operator (MNO). In such examples, each RSU may be part of an intelligent transportation system (ITS) infrastructure and is not associated with an MNO. However, the network node 704 may have access to information about RSU deployment and locations, enabling the network node 704 to determine whether to switch the sensor data transmissions based on the RSU information and a location of the SL UE 702. In such examples, radio resources used for sidelink communication between the SL UE 702 and the one or more RSUs may not be managed by the network node 704. Rather, the SL UE 702 and each RSU, such as the first RSU 708, manage the sensor data transmissions via the sidelink channel. Upon switching from the cellular channel to the sidelink channel, the cellular connection may be released, and the SL UE 702 may enter into an RRC idle or RRC inactive state.

In other examples, the one or more RSUs are associated with the MNO. Specifically, the MNO deploys the one or more RSUs for V2X communication. In such examples, the radio resources used for sidelink communication between the SL UE 702 and the one or more RSUs, such as the first RSU 708, may or may not be managed by the network node 704. If the network node 704 manages sidelink communications (e.g., Mode 1 sidelink), the network node 704 may indicate the redirection of sensor data packets from the cellular channel to the sidelink channel, and vice versa, and grant sidelink resources for the sensor data transmissions. If the network node 704 does not manage the sidelink communications, the network node 704 may request the SL UE 702 to redirect its sensor data transmissions (e.g., sensor data packets) from the cellular channel to the sidelink channel, and vice versa, and to release the cellular connection.

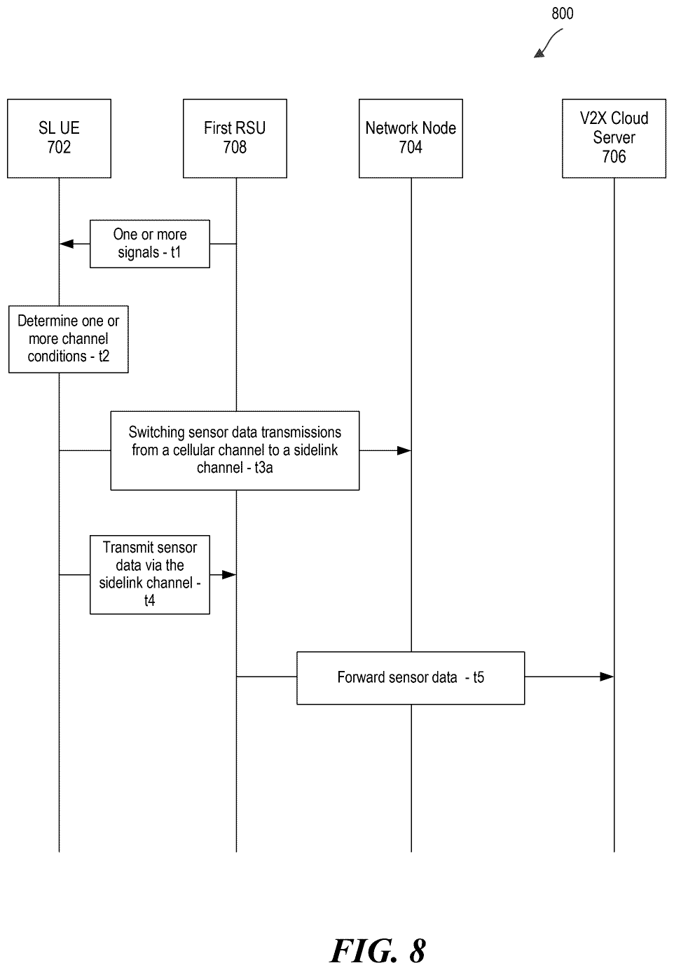

In some implementations, an SL UE may initiate switching sensor data transmissions from a cellular channel to a sidelink channel. FIG. 8 is a timing diagram 800 illustrating an example of an SL UE 702 switching sensor data transmissions from the cellular channel to the sidelink channel, in accordance with various aspects of the present disclosure. In the example of FIG. 8, the SL UE 702 may communicate with a network node 704. The network node 704 and one or more RSUs, including the first RSU 708, may communicate with the V2X cloud server 706.

In the example of FIG. 8, prior to time t1, the SL UE 702 may transmit sensor data to the network node 704 via a cellular channel. The network node 704 may forward the sensor data to the V2X cloud server 706. At time t1, the SL UE 702 may receive one or more signals from the first RSU 708 via a sidelink channel. At time t2, the SL UE 702 may determine one or more channel conditions based on receiving the one or more signals. The one or more channel conditions may be associated with one or more measurements of the one or more signals. At time t3, SL UE 702 transmits, to the network node 704, a message indicating a switch, for sensor data transmissions, from the cellular channel to the sidelink channel in accordance with the one or more channel conditions of the sidelink channel. The one or more channel conditions may include, but are not limited to, one or more of a sidelink reference signal received power (RSRP), a channel busy ratio (CBR), a signal to interference and noise ratio (SINR), channel latency, channel data rate, or a channel quality indicator (CQI). After transmitting the message at time t3, the SL UE 702 may transmit, to the first RSU 708, at time t4, a message including sensor data in accordance with switching sensor data transmissions from the cellular channel to the sidelink channel. That is, the SL UE 702 redirects sensor data packets from the cellular channel to the sidelink channel. Subsequent sensor data transmissions may be performed on the sidelink channel until sensor data transmissions are reverted to the cellular channel. At time t5, the first RSU 708 forwards the sensor data to the V2X cloud server 706. Additionally, for the cellular channel, the SL UE 702 may transition from an RRC connected state to an RRC idle state or inactive state (not shown in the example of FIG. 8).

As discussed, the SL UE 702 may switch sensor data transmissions from the cellular channel to the sidelink channel in accordance with the one or more channel conditions of the sidelink channel. In some examples, the SL UE 702 may initiate the switch based on an uplink transmission data rate on the cellular channel being less than a data rate threshold. This data rate threshold may be dependent on the sensor data transmission specifications and/or an application of the sensor data transmission, such as sensor sharing versus remote driving. Additionally, or alternatively, the switching may be based on cellular uplink latency being greater than a latency threshold. Similar to the data rate, the latency threshold may be dependent on the sensor data transmission specification and/or the application of the sensor data transmission.

Additionally, or alternatively, the SL UE 702 may initiate the switch in accordance with detecting an RSU of the one or more RSUs, such as the first RSU 708. In such examples, the switch may be initiated if the RSU is capable of sending the sensor data to the V2X cloud server 706. Additionally, or alternatively, the SL UE 702 may initiate the switch if one or more sidelink channel measurements satisfy a switching condition. For example, the one or more switching conditions may include, but are not limited to, the sidelink RSRP from the first RSU 708 being greater than an RSRP threshold, the CBR being less than a CBR threshold, the SINR measured from the first RSU 708 being greater than an SINR threshold, the sidelink channel latency being less than a latency threshold, the sidelink channel data rate being greater than a data rate threshold, or the sidelink CQI being greater than a CQI threshold.

In accordance with various aspects, such as the aspects described with reference to FIGS. 7 and 8, a process of switching sensor data transmissions back from the sidelink channel to the cellular channel may be based on one or more switching conditions or a timer. In some examples, the one or more conditions may include, but are not limited to, a location of the SL UE with respect to an RSU and/or channel conditions. For example, the sensor data transmissions may revert to the cellular channel when a distance between the SL UE and the RSU is greater than a distance threshold. Additionally, or alternatively, the sensor data transmissions may revert to the cellular channel if the sidelink RSRP is less than an RSRP threshold.

In some examples, a timer is initiated when the sensor data transmissions are switched from the cellular channel to the sidelink channel. The reversion from the sidelink channel to the cellular channel may be triggered upon expiration of the timer. A value of the timer may be configured by the network entity that initiated the switch (e.g., the SL UE, the network node, or the V2X cloud server).

In some examples, identifiers may be used to route traffic to the V2X cloud server via the RSU and to correlate traffic from the SL UE. In some such examples, sensor data transmissions may include a V2X ID for the RSU to send the SL UE's sensor data to the V2X cloud server. The V2X ID may indicate an identifier, such as an address, associated with a destination for the sensor data. The identifier may be a destination IP address or a layer-2 destination ID. The RSU may send the sensor data packets addressed by the specific V2X ID to a corresponding V2X cloud server.

In some examples, a V2X cloud server may correlate sensor data from the same SL UE or application. In some such examples, an application ID may be assigned to identify the SL UE or the SL UE's sensor data transmission. The application ID may be the same ID regardless of whether the sensor data transmission is via the cellular channel or the sidelink channel.

In other examples, different IDs may be used for the cellular channel transmissions and the sidelink channel transmissions. For example, first sensor data transmissions via the sidelink channel are associated with a first ID and second sensor data transmissions via the cellular channel are associated with a second ID. In some examples, the SL UE may transmit the first ID for sidelink channel transmissions, to the V2X cloud server via the network node. The first ID may be a layer-2 source ID or a source IP address. By transmitting the first ID to the V2X cloud server, the V2X cloud server may correlate the second data from the SL UE after switching to the sidelink channel. Additionally, the UE may transmit the second ID associated with cellular channel transmissions to the V2X cloud server via the RSU. The second ID may be an application ID, international mobile subscriber identity (IMSI), or source IP address. By transmitting the second ID to the V2X cloud server, the V2X cloud server may correlate the second data from the SL UE after the SL UE switches to the sidelink channel.

FIG. 9 is a flow diagram illustrating an example of a process 900 for switching sensor data transmissions from a cellular channel to a sidelink channel, in accordance with various aspects of the present disclosure. The process 900 may be performed by a sidelink (SL) UE in communication with a network node. The SL UE may be an example of UE 104 described with reference to FIGS. 1, 2, and 3, a UE 450, 451, or 452 described with reference to FIG. 4, a UE 502, 504, or 506 described with reference to FIG. 5, or an SL UE 702 described with reference to FIGS. 7 and 8.

The network node may be an example of a network node 102 or a core network 190 described with reference to FIGS. 1 and 2, a CU 310, DU 330, or RU 340 described with reference to FIG. 3, a base station 420 or 421 described with reference to FIG. 4, a network node 508 described with reference to FIG. 5, or a network node 704 described with reference to FIGS. 7 and 8. The V2X cloud server may be an example of the V2X cloud server 550 described with reference to FIG. 5 or a V2X cloud server 706 described with reference to FIGS. 7 and 8. The RSU may be an example of an RSU 510 described with reference to FIG. 5 or the first RSU 708 described with reference to FIGS. 7 and 8.

As shown in the example of FIG. 9, the process 900 begins at block 902 by receiving, from an RSU, one or more signals via an SL channel. At block 904, the process 900 transmits, to a network node, a first message indicating a switch from a cellular channel to the SL channel in accordance with one or more of channel conditions of the SL channel, the one or more channel conditions including one or more of a SL RSRP, a CBR, a SINR, channel latency, channel data rate, or a CQI. Finally, at block 906, the process 900 transmits, to the RSU via the SL channel, a second message including sensor data in accordance with switching from the cellular channel to the SL channel.

FIG. 10 is a flow diagram illustrating an example of a process 1000 for switching sensor data transmissions from a cellular channel to a sidelink channel, in accordance with various aspects of the present disclosure. The process 1000 may be performed by a sidelink (SL) UE in communication with a network node. The SL UE may be an example of UE 104 described with reference to FIGS. 1, 2, and 3, a UE 450, 451, or 452 described with reference to FIG. 4, a UE 502, 504, or 506 described with reference to FIG. 5, or an SL UE 702 described with reference to FIGS. 7 and 8.

The network node may be an example of a network node 102 or a core network 190 described with reference to FIGS. 1 and 2, a CU 310, DU 330, or RU 340 described with reference to FIG. 3, a base station 420 or 421 described with reference to FIG. 4, a network node 508 described with reference to FIG. 5, or a network node 704 described with reference to FIGS. 7 and 8. The V2X cloud server may be an example of the V2X cloud server 550 described with reference to FIG. 5 or a V2X cloud server 706 described with reference to FIGS. 7 and 8. The RSU may be an example of an RSU 510 described with reference to FIG. 5 or the first RSU 708 described with reference to FIGS. 7 and 8.

As shown in the example of FIG. 10, the process 1000 begins at block 1002 by transmitting, to a network node, a first message indicating a current location of the SL UE. At block 1004, the process 1000 receives, from the network node, a second message requesting a switch from a cellular channel to an SL channel in accordance with a distance between the current location of the SL UE and a location of an RSU being less than a distance threshold. At block 1006, the process 1000 transmits, to the RSU via the SL channel, a third message including sensor data in accordance with switching from the cellular channel to the SL channel

Implementation examples are described in the following numbered clauses:

Clause 1. A method for wireless communication by a sidelink (SL) user equipment (UE), comprising: receiving, from a roadside unit (RSU), one or more signals via an SL channel; transmitting, to a network node, a first message indicating a switch from a cellular channel to the SL channel in accordance with one or more of channel conditions of the SL channel, the one or more channel conditions including one or more of a SL reference signal received power (RSRP), a channel busy ratio (CBR), a signal to interference and noise ratio (SINR), channel latency, channel data rate, or a channel quality indicator (CQI); and transmitting, to the RSU via the SL channel, a second message including sensor data in accordance with switching from the cellular channel to the SL channel.

Clause 2. The method of Clause 1, wherein: the second message further includes a vehicle-to-everything (V2X) identifier (ID) associated with the SL UE; the V2X ID indicates an identifier associated with a V2X cloud server; and the sensor data being forwarded, via the RSU, to the V2X cloud server based on the V2X ID.

Clause 3. The method of any one of Clauses 1-2, further comprising transmitting, to the network node prior to the switch, a third message indicating an application identifier (ID) associated with the SL UE, wherein the second message further includes the application ID, wherein first sensor data transmissions via the SL channel and second sensor data transmissions via the cellular channel are associated with the application ID.

Clause 4. The method of any one of Clauses 1-3, wherein: first sensor data transmissions via the SL channel are associated with a first identifier (ID); and second sensor data transmissions via the cellular channel are associated with a second ID.

Clause 5. The method of any one of Clauses 1-4, wherein the sensor data indicates sensor information collected by one or more sensors associated with the SL UE.

Clause 6. The method of any one of Clauses 1-5, wherein the SL UE is a vehicle.

Clause 7. A method for wireless communication by a sidelink (SL) user equipment (UE), comprising: transmitting, to a network node, a first message indicating a current location of the SL UE; receiving, from the network node, a second message requesting a switch from a cellular channel to an SL channel in accordance with a distance between the current location of the SL UE and a location of a roadside unit (RSU) being less than a distance threshold; and transmitting, to the RSU via the SL channel, a third message including sensor data in accordance with switching from the cellular channel to the SL channel.

Clause 8. The method of Clause 7, further comprising transmitting, to the first network node, a fourth message indicating the SL UE accepts the request for the switch in accordance with receiving the second message, wherein the fourth message is transmitted prior to the third message.

Clause 9. The method of any one of Clauses 7-8, wherein the switch is initiated by a vehicle-to-everything (V2X) cloud server in communication with the first network node and the RSU.

Clause 10. The method of any one of Clauses 7-9, wherein the switch is initiated by the first network node.

Clause 11. The method of any one of Clauses 7-10, wherein: the third message further includes a vehicle-to-everything (V2X) identifier (ID) associated with the SL UE; the V2X ID indicates an identifier associated with a V2X cloud server; and the sensor data being forwarded, via the RSU, to the V2X cloud server based on the V2X ID.

Clause 12. The method of any one of Clauses 7-10, further comprising transmitting, to the network node prior to the switch, a fourth message indicating an application identifier (ID) associated with the SL UE, wherein the second message further includes the application ID, wherein first sensor data transmissions via the SL channel and second sensor data transmissions via the cellular channel are associated with the application ID.

Clause 13. The method of any one of Clauses 7-12, wherein: first sensor data transmissions via the SL channel are associated with a first identifier (ID); and second sensor data transmissions via the cellular channel are associated with a second ID.

Clause 14. The method of any one of Clauses 7-13, wherein the sensor data indicates sensor information collected by one or more sensors associated with the SL UE.

Clause 15. An apparatus comprising at least one processor, memory coupled with the least one processor, and instructions stored in the memory and operable, when executed by the least one processor to cause the apparatus to perform any one of Clauses 1-6.

Clause 16. An apparatus comprising at least one means for performing any one of Clauses 1-6.

Clause 17. A computer program comprising code for causing an apparatus to perform any one of Clauses 1-6.

Clause 14. An apparatus comprising at least one processor, memory coupled with the least one processor, and instructions stored in the memory and operable, when executed by the least one processor to cause the apparatus to perform any one of Clauses 7-13.

Clause 15. An apparatus comprising at least one means for performing any one of Clauses 7-13.

Clause 16. A computer program comprising code for causing an apparatus to perform any one of Clauses 7-13.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a sidelink (SL) user equipment (UE), comprising:
receiving, from a roadside unit (RSU), one or more signals via an SL channel;
transmitting, to a network node, a first message indicating a switch from a cellular channel to the SL channel in accordance with one or more of channel conditions of the SL channel, the one or more channel conditions including one or more of a SL reference signal received power (RSRP), a channel busy ratio (CBR), a signal to interference and noise ratio (SINR), channel latency, channel data rate, or a channel quality indicator (CQI); and
transmitting, to the RSU via the SL channel, a second message including sensor data in accordance with switching from the cellular channel to the SL channel.

2. The method of claim 1, wherein:
the second message further includes a vehicle-to-everything (V2X) identifier (ID) associated with the SL UE;
the V2X ID indicates an identifier associated with a V2X cloud server; and
the sensor data being forwarded, via the RSU, to the V2X cloud server based on the V2X ID.

3. The method of claim 1, further comprising transmitting, to the network node prior to the switch, a third message indicating an application identifier (ID) associated with the SL UE, wherein the second message further includes the application ID, wherein first sensor data transmissions via the SL channel and second sensor data transmissions via the cellular channel are associated with the application ID.

4. The method of claim 1, wherein:
first sensor data transmissions via the SL channel are associated with a first identifier (ID); and
second sensor data transmissions via the cellular channel are associated with a second ID.

5. The method of claim 1, wherein the sensor data indicates sensor information collected by one or more sensors associated with the SL UE.

6. An apparatus for wireless communication at a sidelink (SL) user equipment (UE), comprising:
one or more processors; and
one or more memories coupled with the one or more processors and storing processor-executable code that, when executed by the one or more processors, is configured to cause the apparatus to:
receive, from a roadside unit (RSU), one or more signals via an SL channel;
transmit, to a network node, a first message indicating a switch from a cellular channel to the SL channel in accordance with one or more of channel conditions of the SL channel, the one or more channel conditions including one or more of a SL reference signal received power (RSRP), a channel busy ratio (CBR), a signal to interference and noise ratio (SINR), channel latency, channel data rate, or a channel quality indicator (CQI); and
transmit, to the RSU via the SL channel, a second message including sensor data in accordance with switching from the cellular channel to the SL channel.

7. The apparatus of claim 6, wherein:
the second message further includes a vehicle-to-everything (V2X) identifier (ID) associated with the SL UE;
the V2X ID indicates an identifier associated with a V2X cloud server; and
the sensor data being forwarded, via the RSU, to the V2X cloud server based on the V2X ID.

8. The apparatus of claim 6, wherein:
execution of the processor-executable code further causes the apparatus to transmit, to the network node prior to the switch, a third message indicating an application identifier (ID) associated with the SL UE; and
the second message further includes the application ID, wherein first sensor data transmissions via the SL channel and second sensor data transmissions via the cellular channel are associated with the application ID.

9. The apparatus of claim 6, wherein:
first sensor data transmissions via the SL channel are associated with a first identifier (ID); and
second sensor data transmissions via the cellular channel are associated with a second ID.

10. The apparatus of claim 6, wherein the sensor data indicates sensor information collected by one or more sensors associated with the SL UE.

11. A method for wireless communication at a sidelink (SL) user equipment (UE), comprising:
transmitting, to a network node, a first message indicating a current location of the SL UE;
receiving, from the network node, a second message requesting a switch from a cellular channel to an SL channel in accordance with a distance between the current location of the SL UE and a location of a roadside unit (RSU) being less than a distance threshold; and
transmitting, to the RSU via the SL channel, a third message including sensor data in accordance with switching from the cellular channel to the SL channel.

12. The method of claim 11, further comprising transmitting, to the first network node, a fourth message indicating the SL UE accepts the request for the switch in accordance with receiving the second message, wherein the fourth message is transmitted prior to the third message.

13. The method of claim 11, wherein the switch is initiated by a vehicle-to-everything (V2X) cloud server in communication with the first network node and the RSU.

14. The method of claim 11, wherein the switch is initiated by the first network node.

15. The method of claim 11, wherein:
the third message further includes a vehicle-to-everything (V2X) identifier (ID) associated with the SL UE;
the V2X ID indicates an identifier associated with a V2X cloud server; and
the sensor data being forwarded, via the RSU, to the V2X cloud server based on the V2X ID.

16. The method of claim 11, further comprising transmitting, to the network node prior to the switch, a fourth message indicating an application identifier (ID) associated with the SL UE, wherein the second message further includes the application ID, wherein first sensor data transmissions via the SL channel and second sensor data transmissions via the cellular channel are associated with the application ID.

17. The method of claim 11, wherein:
first sensor data transmissions via the SL channel are associated with a first identifier (ID); and
second sensor data transmissions via the cellular channel are associated with a second ID.

18. The method of claim 11, wherein the sensor data indicates sensor information collected by one or more sensors associated with the SL UE.
